(19) United States
(12) Patent Application Publication
(10) Pub. No.: US 2026/0258565 A1
(43) Pub. Date: Sep. 3, 2026

(54) ELECTROLYTIC CELL UNIT

(71) Applicant: TOKUYAMA CORPORATION, Shunan-shi, Yamaguchi (JP)

(72) Inventor: Hitoshi MATSUI, Shunan-shi (JP)

(73) Assignee: TOKUYAMA CORPORATION, Shunan-shi, Yamaguchi (JP)

(21) Appl. No.: 18/868,131

(22) PCT Filed: Apr. 3, 2023
(86) PCT No.: PCT/JP2023/013756

§ 371 Date: Nov. 21, 2024

(30) Foreign Application Priority Data
May 31, 2022 (JP) 2022-089229

(51) Int. Cl. C25B 15/08; B01D 19/00; C25B 1/46; C25B 9/60

(52) U.S. Cl. CPC C25B 15/08; B01D 19/0031; C25B 9/60; C25B 1/46

(57) ABSTRACT

Provided is an electrolytic cell unit capable of promoting gas-liquid separation. An electrolytic cell unit 2 includes an electrode chamber 4 (anode chamber 8, cathode chamber 10), an anode-side gas-liquid separation chamber 30 arranged above the anode chamber 8, and a cathode-side gas-liquid separation chamber 32 arranged above the cathode chamber 10. A partition plate 40, which partitions off the anode chamber 8 and the anode-side gas-liquid separation chamber 30, has a plurality of slits 42 extending in a depth direction at intervals in a width direction, and a partition plate 54, which partitions off the cathode chamber 10 and the cathode-side gas-liquid separation chamber 32, has a plurality of slits 56 extending in the depth direction at intervals in the width direction.

### TECHNICAL FIELD

The present invention relates to an electrolytic cell unit that can be used for the electrolysis of an aqueous solution of an alkali metal chloride, such as salt electrolysis, or the electrolysis of an alkali metal hydroxide such as potassium hydroxide.

### BACKGROUND ART

PTL 1 below discloses an electrolytic cell unit that is a component of a bipolar electrolytic cell for electrolyzing an aqueous solution of an alkali metal chloride to produce chlorine and an alkali metal hydroxide. This electrolytic cell unit includes an electrode chamber and a gas-liquid separation chamber arranged above the electrode chamber.

In this gas-liquid separation chamber, an upper portion of a back plate located above an electrode plate (anode plate or cathode plate) of an electrode chamber frame is outwardly bent to form an inverse U shape, U-shaped trough members is arranged in this inverse U-shape portion so that a gap serving as a passage is provided between the back plate and the channel member, and the gas-liquid separation chamber is defined by the inverse U-shaped portion and the U-shaped channel member.

PTL 1 indicates that in this electrolytic cell unit, the gas-liquid multiphase flow that has risen inside the electrode chamber enters the gas-liquid separation chamber as if being sucked up by the siphon effect from the passage provided on the side of the gas-liquid separation chamber, so gas is less likely to accumulate at the bottom outside of the gas-liquid separation chamber, and as the gas-liquid multiphase flow passes through the narrow passage, the flow becomes a bubble flow, in which small bubbles are dispersed, and gas-liquid separation is carried out smoothly.

### PRIOR ART(S)

### Patent Literature

PTL 1: JP H08-100286 A

### SUMMARY OF INVENTION

### Problem(s) to Be Solved by the Invention

However, since small air bubbles are difficult to separate from the liquid, there is room for improvement in terms of gas-liquid separation property of the electrolytic cell unit. In a case where separation of the gas and liquid is insufficient, vibrations are likely to occur due to pressure fluctuations in the electrolytic cell, and such vibrations may damage the membrane (an ion exchange membrane in the case of electrolysis of an aqueous solution of an alkali metal chloride, such as salt electrolysis, or a diaphragm in the case of electrolysis of an alkali metal hydroxide such as potassium hydroxide).

An object of the present invention is to provide an electrolytic cell unit that can promote gas-liquid separation.

### Means for Solving the Problem(s)

The present invention provides the following electrolytic cell unit that solves the above problems. That is, provided is
“An electrolytic cell unit comprising an electrode chamber and a gas-liquid separation chamber arranged above the electrode chamber, wherein
a partition plate partitioning off the electrode chamber and the gas-liquid separation chamber has a plurality of slits extending in a depth direction at intervals in a width direction.”

Preferably, an additional plate is provided above the partition plate, and the additional plate has a plurality of slits extending in the depth direction at intervals in the width direction.

It is desirable that the slits in the partition plate and the slits in the additional plate be arranged alternately in the width direction. The width of the slits in the additional plate is preferably smaller than the width of the slits in the partition plate. The number of slits in the additional plate is preferably less than the number of slits in the partition plate.

A first additional plate and a second additional plate spaced apart from each other in a vertical direction may be provided above the partition plate, and each of the first additional plate and the second additional plate may have a plurality of slits extending in the depth direction at intervals in the width direction.

The slits in the partition plate and the slits in the first additional plate are preferably arranged alternately in the width direction. The width of the slits in the first additional plate which is smaller than the width of the slits in the partition plate, is desirable. It is desirable that the number of slits in the first additional plate be less than the number of slits in the partition plate.

The slits in the first additional plate and the slits in the second additional plate can be arranged alternately in the width direction. The width of the slits in the second additional plate is preferably smaller than the width of the slits in the first additional plate. The number of slits in the second additional plate is preferably smaller than the number of slits in the first additional plate.

The first additional plate and the second additional plate are preferably linked by a linking piece extending in the vertical direction along a side wall of the gas-liquid separation chamber.

### Advantageous Effects of Invention

In the electrolytic cell unit of the present invention, when the bubbles generated in the electrode chamber pass through the slits in the partition plate, the bubbles coalesce and split, narrowing the bubble size distribution and increasing the proportion of bubbles of a size that is prone to collapsing in the gas-liquid separation chamber, thereby promoting gas-liquid separation.

### BRIEF DESCRIPTION OF DRAWINGS

FIG. 1 is a front view of a first embodiment of an electrolytic cell unit configured in accordance with the present invention.

FIG. 2 is a cross-sectional view taken along line II-II in FIG. 1.

FIG. 3 is a cross-sectional view (corresponding to the cross-section in FIG. 2) in the case where no clad plate is interposed.

FIG. 4 is an enlarged view of the gas-liquid separation chamber shown in FIG. 2.

FIG. 5 is a view taken from the V direction in FIG. 4.

FIG. 6 is a cross-sectional view of a second embodiment of an electrolytic cell unit configured in accordance with the present invention.

FIG. 7(a) is an enlarged cross-sectional view taken along line VII-VII in FIG. 6, FIG. 7(b) is a cross-sectional view taken along line VII-VII in the case where the width of the slits in the additional plate is smaller than the width of the slits in the partition plate.

FIG. 8 is a cross-sectional view of a third embodiment of an electrolytic cell unit configured in accordance with the present invention.

FIG. 9 is an enlarged cross-sectional view taken along line IX-IX in FIG. 8.

FIG. 10 is a cross-sectional view along line IX-IX in the case where the width of the slits in the first additional plate is smaller than the width of the slits in the partition plate, and the width of the slits in the second additional plate is smaller than the width of the slits in the first additional plate.

### DESCRIPTION OF EMBODIMENTS

### First Embodiment

First, a first embodiment of the electrolytic cell unit of the present invention will be described with reference to the drawings.

### Electrolytic Cell Unit 2

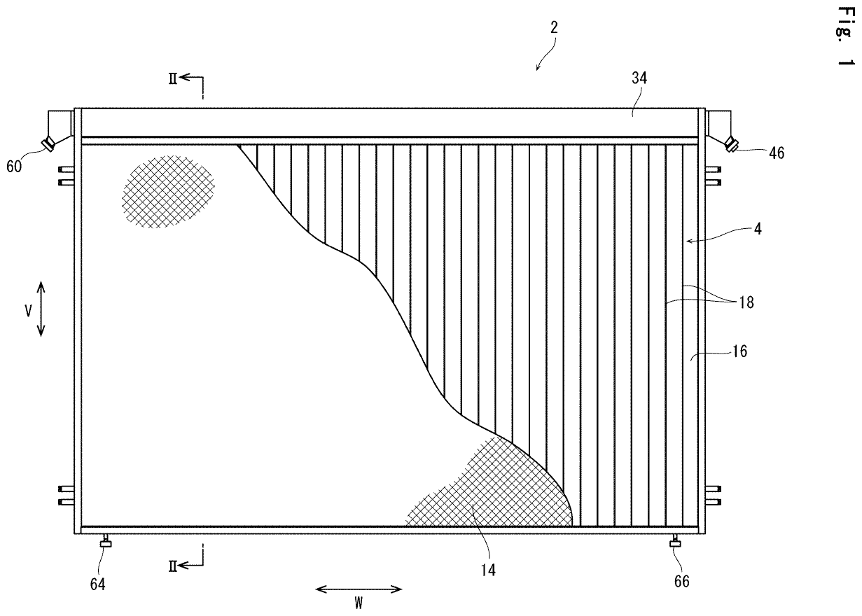

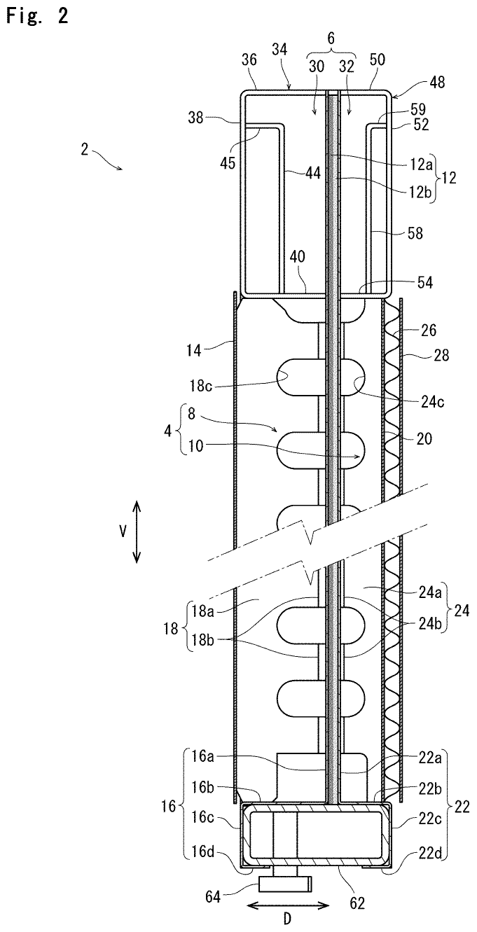

Referring to FIGS. 1 and 2, an electrolytic cell unit 2 comprises an electrode chamber 4 in which electrolysis of liquid is performed, and a gas-liquid separation chamber 6 (see FIG. 2) for separating the gas generated by electrolysis from an electrolytic solution.

### Electrode Chamber 4

As shown in FIG. 2, the electrode chamber 4 includes an anode chamber 8 formed from a first material, and a cathode chamber 10 formed from a second material. In the illustrated embodiment, the anode chamber 8 and the cathode chamber 10 are connected through a clad plate 12 having a layer 12a of the first material and a carbon steel 12b. In applications for the electrolysis of an aqueous solution of an alkali metal chloride, for example, the first material may be titanium (Ti) and the second material may be nickel (Ni). Furthermore, in applications for the electrolysis of an alkali metal hydroxides, the first and second materials may be the same, for example nickel (Ni), and the clad plate 12 is not required.

### Anode Chamber 8

As shown in FIG. 2, the anode chamber 8 made of the first material (for example, titanium) includes an anode plate 14, a first partition wall 16 arranged at a distance from the anode plate 14, and a plurality of first ribs 18 arranged between the anode plate 14 and the first partition wall 16.

### Anode Plate 14

The rectangular anode plate 14 is provided with multiple openings (not shown). The shape of the openings can be freely selected, and examples include a diamond shape, a flat fan shape, and a slit shape. The multiple openings may be arranged in a staggered pattern.

### First Partition Wall 16

The first partition wall 16 is arranged at intervals from the anode plate 14 in the depth direction (D direction) indicated by an arrow D in FIG. 2. As shown in FIG. 2, the first partition wall 16 has a main portion 16a extending in the up-down direction (V direction) indicated by an arrow V in FIG. 2, a bottom portion 16b extending in the depth direction from the lower end of the main portion 16a toward the anode plate 14, a flange portion 16c extending downward from the tip of the bottom portion 16b, and a protruding portion 16d protruding in the depth direction from the lower end of the flange portion 16c toward the main portion 16a side.

Although not shown, both side portions of the first partition wall 16 in the width direction (the direction indicated by an arrow W in FIG. 1) are provided with side portions extending in the depth direction from the ends of the main portion 16a in the width direction toward the anode plate 14, flange portions extending outward in the width direction from the tips of the side portions, and protruding portions protruding in the depth direction from the outer ends of the flange portions toward the main portion 16a.

### First Ribs 18

As shown in FIG. 1, a plurality of first ribs 18 is provided at intervals in the width direction. Each first rib 18 extends in the up-down direction (V direction). Referring to FIG. 2, the first rib 18 has a main portion 18a extending in the depth direction from the anode plate 14 toward the first partition wall 16, and a plurality of joint pieces 18b protruding in the width direction from the end of the main portion 18a on the first partition wall 16 side.

The end of the main portion 18a on the anode plate 14 side is joined to the anode plate 14, and each joint piece 18b is joined to the main portion 16a of the first partition wall 16. As can be understood by referring to FIG. 2, a plurality of notches 18c arranged at intervals in the vertical direction is provided at the end of the main portion 18a on the first partition wall 16 side. The notches 18c are located between the adjacent joint pieces 18b. The plurality of notches 18c ensure the flow of liquid and gas in the width direction within the anode chamber 8.

### Cathode Chamber 10

As shown in FIG. 2, the cathode chamber 10 made of the second material (for example, nickel) includes a current collector 20, a second partition wall 22 arranged at intervals from the current collector 20, and a plurality of second ribs 24 arranged between the current collector 20 and the second partition wall 22.

### Current Collector 20

The rectangular current collector 20 is provided with multiple openings (not shown), similar to the anode plate 14. The shape of the openings can be freely selected, and examples include a diamond shape, a flat fan shape, and a slit shape. The multiple openings may be arranged in a staggered pattern.

When multiple electrolytic cell units 2 are arranged side by side in the depth direction and pressed from both sides in the depth direction to assemble an electrolytic cell, a cathode plate 28 is attached to the outer surface of the current collector 20 through a metallic cushioning material 26.

### Second Partition Wall 22

The second partition wall 22 is arranged at intervals from the current collector 20 in the depth direction (D direction). As shown in FIG. 2, like the first partition wall 16, the second partition wall 22 has a main portion 22a extending in the up-down direction (V direction), a bottom portion 22b extending in the depth direction from the lower end of the main portion 22a toward the current collector 20, a flange portion 22c extending downward from the tip of the bottom portion 22b, and a protruding portion 22d protruding in the depth direction from the lower end of the flange portion 22c toward the main portion 22a side.

Although not shown, both side portions of the second partition wall 22 in the width direction (W direction) are provided with side portions extending in the depth direction from the width direction end of the main portion 22a toward the current collector 20, flange portions extending outward in the width direction from the tips of the side portions, and protruding portions protruding in the depth direction from the outer ends of the flange portions toward the main portion 22a side.

### Second Ribs 24

Similar to the first ribs 18, a plurality of second ribs 24 is arranged at intervals in the width direction and extends along the up-down direction (V direction). The plurality of second ribs 24 are arranged at positions in the width direction corresponding to the positions of the plurality of first ribs 18. The second rib 24 has a main portion 24a extending in the depth direction from the current collector 20 toward the second partition wall 22, and a plurality of joint pieces 24b protruding in the width direction from the end of the main portion 24a on the second partition wall 22 side.

The end of the main portion 24a on the current collector 20 side is joined to the current collector 20, and each joint piece 24b is joined to the main portion 22a of the second partition wall 22. As can be understood by referring to FIG. 2, a plurality of notches 24c arranged at intervals in the vertical direction is provided at the end of the main portion 24a on the second partition wall 22 side. The notches 24c are located between the adjacent joint pieces 24b. The plurality of notches 24c ensure the flow of liquid and gas in the width direction within the cathode chamber 10.

### Clad Plate 12

The clad plate 12 is provided as a plurality of pieces arranged at intervals in the width direction and extends in the vertical direction. The clad plate 12 is arranged between the back surface of the first partition wall 16 and the back surface of the second partition wall 22 at a position corresponding to the joint piece 18b of the first rib 18 and the joint piece 24b of the second rib 24.

The clad plate 12 in the illustrated embodiment is a plate material having a two-layer structure in which the layer 12a of a first material (for example, a titanium layer) and the carbon steel 12b are joined by explosive cladding. The layer 12a of the first material is joined to the back surface of the first partition wall 16 made of the first material, and the carbon steel 12b is joined to the back surface of the second partition wall 22 made of the second material.

As described above, when the electrolytic cell unit 2 is applied to the electrolysis of an alkali metal hydroxide, the first and second materials may be the same, for example, nickel (Ni) may be used, and the clad plate 12 is not required. When the clad plate 12 is not interposed, the anode chamber 8 and the cathode chamber 10 are directly connected. Specifically, the main portion 16a of the first partition wall 16 and the main portion 22a of the second partition wall 22 may be joined together.

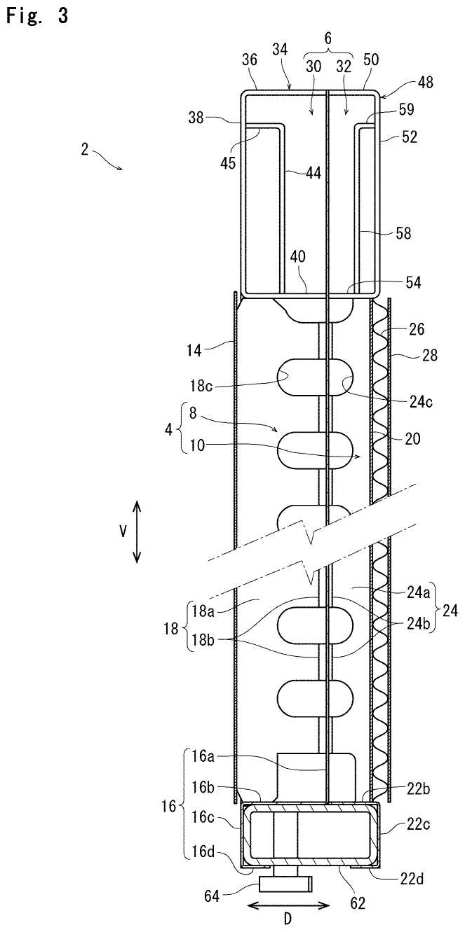

Alternatively, where the clad plate 12 is not interposed, the main portion 22a of the second partition wall 22 may not be provided. That is, as shown in FIG. 3, the anode chamber 8 and the cathode chamber 10 may be separated by the main portion 16a of the first partition wall 16. In this case, the main portion 22a of the second partition wall 22 is not provided, but members corresponding to the bottom portion 22b, flange portion 22c, and protruding portion 22d of the second partition wall 22 are connected to the lower portion of the first partition wall 16 (see FIG. 3). In addition, although not shown, members corresponding to the side portion, flange portion, and protruding portion of the second partition wall 22 are connected to both side portions of the first partition wall 16 in the width direction.

When the clad plate 12 is not interposed, by contrast with the configuration shown in FIG. 3, the main portion 16a of the first partition wall 16 may not be provided, and the anode chamber 8 and the cathode chamber 10 may be separated by the main portion 22a of the second partition wall 22. In this case, the main portion 16a of the first partition wall 16 is not provided, but members corresponding to the bottom portion 16b, flange portion 16c, and protruding portion 16d of the first partition wall 16 are connected to the lower portion of the second partition wall 22. In addition, members corresponding to the side portion, flange portion, and protruding portion of the first partition wall 16 are connected to both side portions of the second partition wall 22 in the width direction.

In the case described hereinbelow, the clad plate 12 is interposed, but in the case of a configuration where the clad plate 12 and the main portion 22a of the second partition wall 22 are not provided (for example, the configuration shown in FIG. 3), the second partition wall 22 is to be read as the first partition wall 16. In addition, in the case of a configuration where the clad plate 12 and the main portion 16a of the first partition wall 16 are not provided (not shown), the first partition wall 16 is to be read as the second partition wall 22.

### Gas-Liquid Separation Chamber 6

The gas-liquid separation chamber 6 has an anode-side gas-liquid separation chamber 30 arranged above the anode chamber 8, and a cathode-side gas-liquid separation chamber 32 arranged above the cathode chamber 10. The anode-side gas-liquid separation chamber 30 is formed from a first material such as titanium, and the cathode-side gas-liquid separation chamber 32 is formed from a second material such as nickel.

### Anode-Side Gas-Liquid Separation Chamber 30

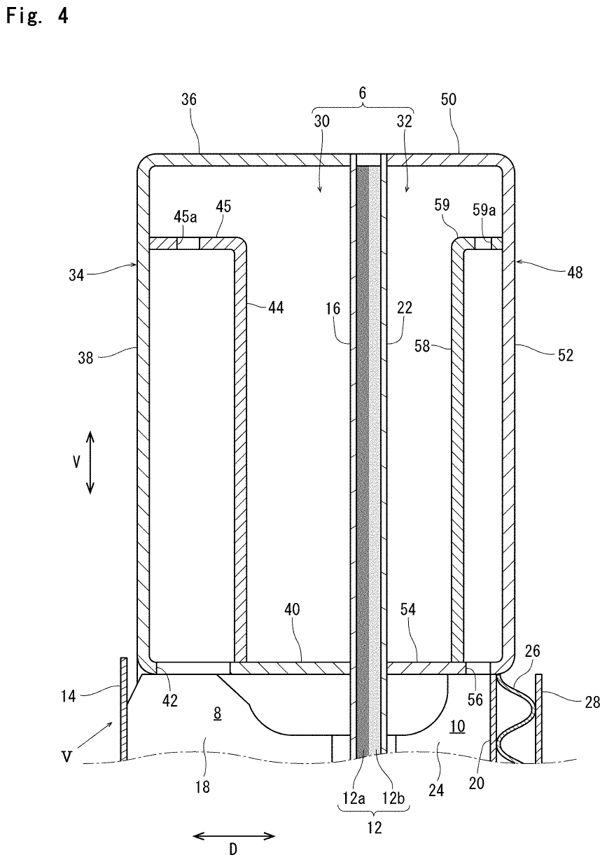

Referring to FIGS. 2 and 4, the anode-side gas-liquid separation chamber 30 is formed by the upper end portion of the first partition wall 16 and a first flange member 34 made of the first material. The first flange member 34 includes a top plate 36 extending in the depth direction from the upper end of the first partition wall 16, a side wall 38 extending downward from the tip of the top plate 36, and a partition plate 40 extending in the depth direction from the lower end of the side wall 38 toward the first partition wall 16. Although not shown, a protruding piece protruding upward may be provided at the base end (end on the first partition wall 16 side) of the top plate 36.

### Slits 42

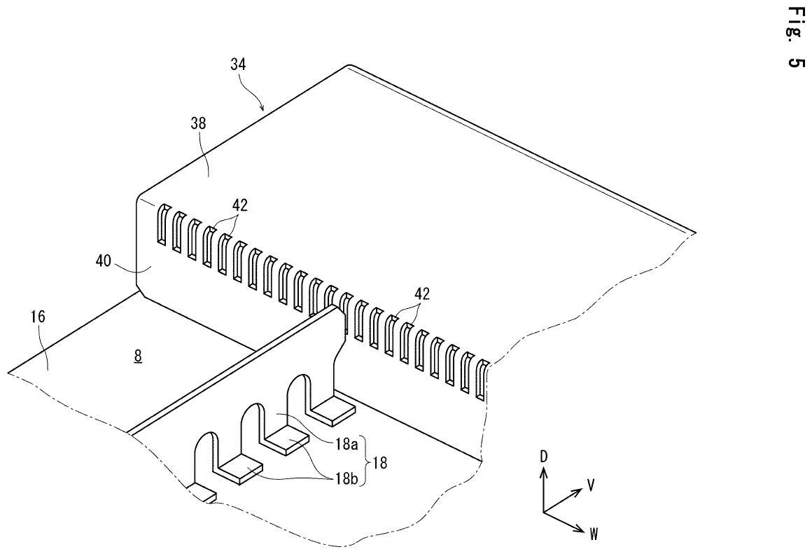

The partition plate 40 partitions off the anode chamber 8 and the anode-side gas-liquid separation chamber 30. As shown in FIG. 5, a plurality of slits 42 extending in the depth direction (D direction) is formed in the partition plate 40 at intervals in the width direction (W direction). The plurality of slits 42 ensure the flow of liquid and gas from the anode chamber 8 to the gas-liquid separation chamber 30.

### Vertical Separating Plate 44

As shown in FIG. 4, a vertical separating plate 44 dividing the anode-side gas-liquid separation chamber 30 in the depth direction into the side wall 38 side and the first partition wall 16 side is arranged on the upper surface of the partition plate 40, and a plurality of slits 42 is provided between the vertical separating plate 44 and the side wall 38. The upper end of the vertical separating plate 44 is lower than the lower surface of the top plate 36, allowing liquid and gas in the gas-liquid separation chamber 30 to move over the vertical separating plate 44. The upper end of the vertical separating plate 44 is linked to the side wall 38 by a horizontal separating plate 45, and a plurality of openings 45a is formed in the horizontal separating plate 45 to allow the movement of liquid and gas.

### Discharge Nozzle 46

Although not shown, both ends of the top plate 36 in the width direction are closed by the side portions of the first partition wall 16. One of the side portions of the first partition wall 16 is provided with a discharge nozzle 46 (see FIG. 1) for discharging liquid and gas from the anode-side gas-liquid separation chamber 30.

### Cathode-Side Gas-Liquid Separation Chamber 32

As shown in FIG. 4, the cathode-side gas-liquid separation chamber 32 is constituted by the upper end portion of the second partition wall 22 and a second flange member 48 made of the second material. The second flange member 48 includes a top plate 50 extending in the depth direction from the upper end of the second partition wall 22, a side wall 52 extending downward from the tip of the top plate 50, and a partition plate 54 extending in the depth direction from the lower end of the side wall 52 toward the second partition wall 22. Although not shown, the base end of the top plate 50 (the end on the second partition wall 22 side) may be provided with a protruding piece that protrudes upward.

### Slits 56

The partition plate 54 partitions off the cathode chamber 10 and the cathode side gas-liquid separation chamber 32. A plurality of slits 56 extending in the depth direction is formed in the partition plate 54 at intervals in the width direction. The plurality of slits 56 ensure the flow of liquid and gas from the cathode chamber 10 to the gas-liquid separation chamber 32.

### Vertical Separating Plate 58

A vertical separating plate 58 dividing the cathode-side gas-liquid separation chamber 32 in the depth direction into the side wall 52 side and the second partition wall 22 side is joined to the upper surface of the partition plate 54, and the plurality of slits 56 are provided between the vertical separating plate 58 and the side wall 52. The upper end of the vertical separating plate 58 is lower than the lower surface of the top plate 50, allowing liquid and gas in the gas-liquid separation chamber 32 to move over the vertical separating plate 58. The upper end of the vertical separating plate 58 is linked to the side wall 52 by a horizontal separating plate 59, and a plurality of openings 59a is formed in the horizontal separating plate 59 to allow the movement of liquid and gas.

### Discharge Nozzle 60

Although not shown, both ends of the top plate 50 in the width direction are closed by the side portions of the second partition wall 22. One of the side portions of the second partition wall 22 is provided with a discharge nozzle 60 (see FIG. 1) for discharging liquid and gas from the cathode-side gas-liquid separation chamber 32.

### Lower Frame 62

As shown in FIG. 2, a hollow lower frame 62 with a rectangular cross section is provided at the bottom of the electrolytic cell unit 2. The lower frame 62 can be made of an appropriate metal material such as stainless steel. The lower frame 62 is provided with two through holes (not shown) that penetrate in the vertical direction.

### Supply Nozzles 64 and 66

A supply nozzle 64 (see FIGS. 1 and 2) for supplying raw material liquid to the anode chamber 8 is attached to one of the through holes of the lower frame 62. A supply nozzle 66 (see FIG. 1) for supplying raw material liquid to the cathode chamber 10 is attached to the other through hole of the lower frame 62. Although not shown, side frames are provided on both ends of the electrolytic cell unit 2 in the width direction.

### Electrolytic Cell

When assembling an electrolytic cell, multiple electrolytic cell units 2 described above are prepared, multiple electrolytic cell units 2 are arranged side by side in the depth direction so that the anode plate 14 and the cathode plate 28 face each other, and an ion exchange membrane or a diaphragm (not shown) is arranged between the anode plate 14 and the cathode plate 28. Then, multiple electrolytic cell units 2 are pressed from both sides in the depth direction using a hydraulic press or the like. In addition, hoses or other flow path members are connected to the supply nozzles 64 and 66 and the discharge nozzles 46 and 60.

### Electrolysis

When electrolysis is performed in the electrolytic cell, a raw liquid is supplied to the anode chamber 8 through the supply nozzle 64, and a raw liquid is supplied to the cathode chamber 10 through the supply nozzle 66. When a voltage is applied to the anode plate 14 and the cathode plate 28, gas is generated in the anode chamber 8 and the cathode chamber 10, and an electrolytic solution containing a large number of bubbles is generated.

The generated bubble-containing electrolytic solution rises from the anode chamber 8 to the anode-side gas-liquid separation chamber 30, and also rises from the cathode chamber 10 to the cathode-side gas-liquid separation chamber 32. When the bubble-containing electrolytic solution passes through the slits 42 and 56 in the partition plates 40 and 54, the bubbles coalesce and split. Although multiple slits 42 and 56 are formed in the partition plates 40 and 54, the rising of the bubbles is temporarily hindered by the partition plates 40 and 54, so that collisions between the bubbles and between the bubbles and the partition plates 40 and 54 cause the bubbles to coalesce and split.

When the bubbles rise in the anode chamber 8 or the cathode chamber 10, they also collide with each other and coalesce and split, but in the slits 42 and 56 in the partition plates 40 and 54, the bubbles collide with each other with greater intensity than when the bubbles rise in the anode chamber 8 or the cathode chamber 10, and the bubbles also collide with the partition plates 40 and 54, with result of promoting the coalescence and splitting of the bubbles.

In the anode chamber 8 and the cathode chamber 10, bubbles of various sizes, large and small, are generated. When such a group of bubbles passes through the slits 42 and 56 in the partition plates 40 and 54, the relatively small bubbles that lead to deterioration of gas-liquid separation coalesce with other bubbles. Furthermore, the relatively large bubbles that, when they burst, cause pressure fluctuations that lead to damage to the ion exchange membrane or diaphragm are split into smaller bubbles. In this way, the number of relatively small and relatively large bubbles is reduced and the bubble size distribution is narrowed, thereby increasing the proportion of bubbles of a size such that bursting is facilitated and the occurrence of pressure fluctuations that lead to damage to the ion exchange membrane or diaphragm is avoided even when the bubbles burst.

Therefore, in the bubble-containing electrolytic solution that has passed through the slits 42 and 56 in the partition plates 40 and 54 and flowed into the anode-side and cathode-side gas-liquid separation chambers 30 and 32, the proportion of bubbles of a size that facilitates bursting increases, thereby promoting gas-liquid separation in the gas-liquid separation chambers 30 and 32. The bubble-containing electrolytic solution that flowed into the gas-liquid separation chambers 30 and 32 is separated into gas and liquid and discharged from the discharge nozzles 46 and 60.

As described above, in the electrolytic cell unit 2, when the bubbles generated in the anode chamber 8 and the cathode chamber 10 pass through the slits 42 and 56 in the partition plates 40 and 54, the bubbles coalesce and split, narrowing the bubble size distribution and increasing the proportion of bubbles of a size that facilitates bursting, thereby promoting gas-liquid separation.

### Second Embodiment

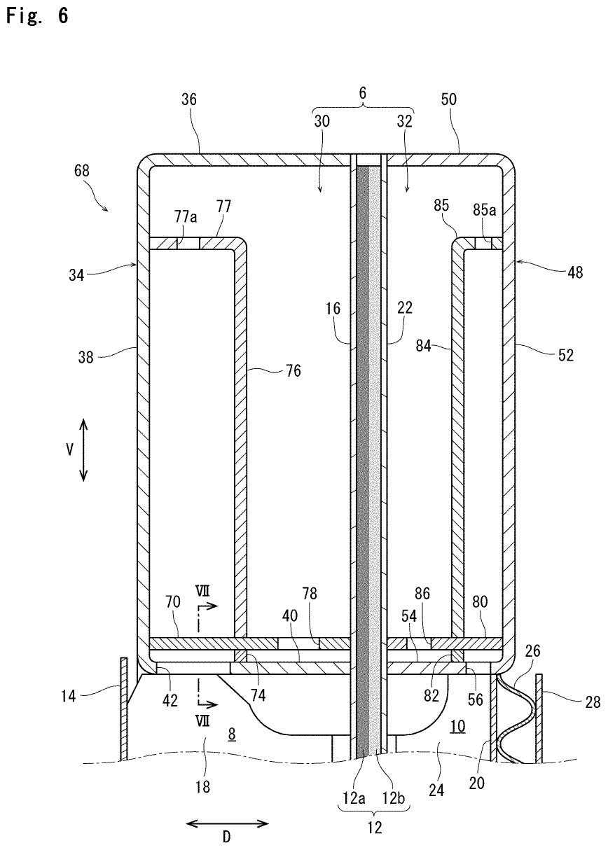

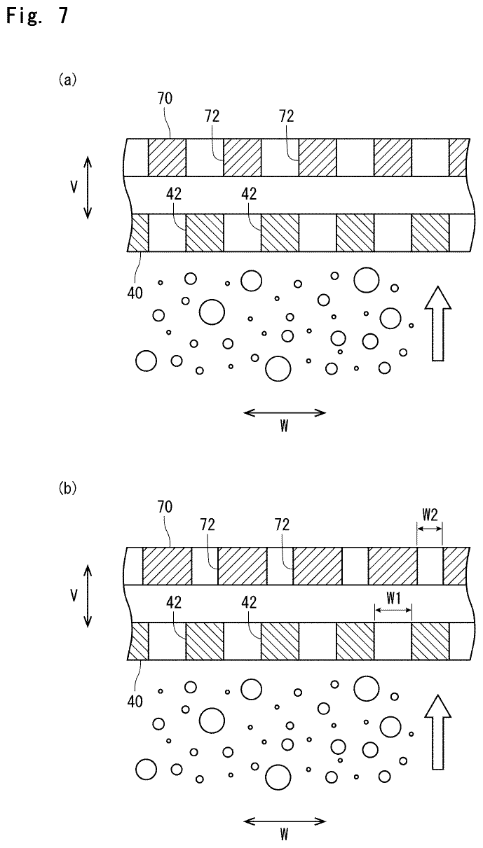

Next, a second embodiment of the electrolytic cell unit of the present invention will be described with reference to FIGS. 6 and 7. In the second embodiment, the same components as those in the first embodiment are given of the same reference numerals as those in the first embodiment, so that the explanation thereof is omitted.

### Anode-Side Additional Plate 70

As shown in FIG. 6, in an electrolytic cell unit 68 of the second embodiment, an additional plate 70 made of a first material (for example, titanium) is provided above the partition plate 40 that partitions off the anode chamber 8 and the gas-liquid separation chamber 30. One end of the additional plate 70 in the depth direction is in contact with the side wall 38, and the other end of the additional plate 70 in the depth direction is in contact with the first partition wall 16.

### Slits 72

As shown in FIG. 7, a plurality of slits 72 extending in the depth direction (D direction) at intervals in the width direction (W direction) have been formed in the additional plate 70. The plurality of slits 72 are located above the slits 42 in the partition plate 40. It is preferable that the slits 42 in the partition plate 40 and the slits 72 in the additional plate 70 satisfy one or more of the following conditions (a) to (c).
(a) The slits 42 in the partition plate 40 and the slits 72 in the additional plate 70 are arranged alternately in the width direction (see FIG. 7(a) and 7(b)).
(b) The width W2 of the slits 72 in the additional plate 70 is smaller than the width W1 of the slits 42 in the partition plate 40 (W2<W1, see FIG. 7(b)).
(c) The number of slits 72 in the additional plate 70 is smaller than the number of slits 42 in the partition plate 40.

### Separating Piece 74

Referring to FIG. 6, a separating piece 74 made of the first material and dividing the anode-side gas-liquid separation chamber 30 in the depth direction into the side wall 38 side and the first partition wall 16 side is provided between the partition plate 40 and the additional plate 70. The lower end of the separating piece 74 is joined or fitted to the partition plate 40, and the upper end of the separating piece 74 is joined or fitted to the additional plate 70. The slits 42 in the partition plate 40 and the slits 72 in the additional plate 70 are located between the separating piece 74 and the side wall 38.

### Vertical Separating Plate 76

A vertical separating plate 76 made of the first material and dividing the gas-liquid separation chamber 30 in the depth direction into the side wall 38 side and the first partition wall 16 side is joined or fitted to the upper surface of the additional plate 70 (directly above the separating piece 74). The upper end of the vertical separating plate 76 is lower than the lower surface of the top plate 36, and liquid and gas in the gas-liquid separation chamber 30 can move over the vertical separating plate 76. The upper end of the vertical separating plate 76 is linked to the side wall 38 by the horizontal separating plate 77, and a plurality of openings 77a to allow the movement of liquid and gas have been formed in the horizontal separating plate 77.

The additional plate 70 is provided with a plurality of through holes 78 that allows the movement of liquid and gas in the gas-liquid separation chamber 30. The through holes 78 are located between the vertical separating plate 76 and the first partition wall 16.

### Cathode-Side Additional Plate 80

An additional plate 80 made of a second material (for example, nickel) is provided above the partition plate 54 that partitions off the cathode chamber 10 and the gas-liquid separation chamber 32. One end of the additional plate 80 in the depth direction is in contact with the side wall 52, and the other end of the additional plate 80 in the depth direction is in contact with the second partition wall 22.

### Slits in Additional Plate 80

Although not shown, a plurality of slits extending in the depth direction at intervals in the width direction is formed in the additional plate 80, similar to the anode-side additional plate 70. The plurality of slits are located above the slits 56 in the partition plate 54. It is preferable that the slits 56 in the partition plate 54 and the slits in the additional plate 80 also satisfy one or more of the following conditions (d) to (f).
(d) The slits 56 in the partition plate 54 and the slits in the additional plate 80 are arranged alternately in the width direction.
(e) The width of the slits in the additional plate 80 is smaller than the width of the slits 56 in the partition plate 54.
(f) The number of slits in the additional plate 80 is less than the number of slits 56 in the partition plate 54.

### Separating Piece 82

A separating piece 82 made of the second material and dividing the cathode-side gas-liquid separation chamber 32 in the depth direction into the side wall 52 side and the second partition wall 22 side is provided between the partition plate 54 and the additional plate 80. The lower end of the separating piece 82 is joined or fitted to the partition plate 54, and the upper end of the separating piece 82 is joined or fitted to the additional plate 80. The slits 56 in the partition plate 54 and the slits in the additional plate 80 are located between the separating piece 82 and the side wall 52.

### Vertical Separating Plate 84

A vertical separating plate 84 made of the second material and dividing the gas-liquid separation chamber 32 in the depth direction into the side wall 52 side and the second partition wall 22 side is joined or fitted to the upper surface of the additional plate 80 (directly above the separating piece 82). The upper end of the vertical separating plate 84 is lower than the lower surface of the top plate 50, and liquid and gas in the gas-liquid separation chamber 32 can move over the vertical separating plate 84. The upper end of the vertical separating plate 84 is linked to the side wall 52 by a horizontal separating plate 85, and a plurality of openings 85a to allow the movement of liquid and gas have been formed in the horizontal separating plate 85.

### Through Holes 86

The additional plate 80 is provided with a plurality of through holes 86 that allows the movement of liquid and gas in the gas-liquid separation chamber 32, similar to the anode-side additional plate 70. The through holes 86 are located between the vertical separating plate 84 and the second partition wall 22.

In the second embodiment as well, the gas bubble-containing electrolytic solution rises from the anode chamber 8 to the anode-side gas-liquid separation chamber 30, and the gas bubble-containing electrolytic solution also rises from the cathode chamber 10 to the cathode-side gas-liquid separation chamber 32. When the bubble-containing electrolytic solution passes through the slits 42 and 56 in the partition plates 40 and 54, the bubbles coalesce and split, and the bubbles also coalesce and split when passing through the slits 72 in the additional plate 70 and the slits in the additional plate 80. Therefore, in the second embodiment, the coalescence and splitting of the bubbles is promoted more than in the first embodiment, with result that the gas-liquid separation property is improved.

Furthermore, as in the second embodiment, where the slits 42 in the anode-side partition plate 40 and the slits 72 in the additional plate 70 are arranged alternately in the width direction (see FIG. 7), and the slits 56 in the cathode-side partition plate 54 and the slits in the additional plate 80 are arranged alternately in the width direction (where the above conditions (a) and (d) are satisfied), the coalescence and splitting of the bubbles are further promoted.

Furthermore, where the width W2 of the slits 72 in the additional plate 70 is smaller than the width W1 of the slits 42 in the partition plate 40, and the width of the slits in the additional plate 80 is smaller than the width of the slits 56 in the partition plate 54 (where the above conditions (b) and (e) are satisfied), or where the number of slits 72 in the additional plate 70 is smaller than the number of slits 42 in the partition plate 40, and the number of slits in the additional plate 80 is smaller than the number of slits 56 in the partition plate 54 (where the above conditions (c) and (f) are satisfied), the coalescence and splitting of the bubbles are promoted more effectively.

### Third Embodiment

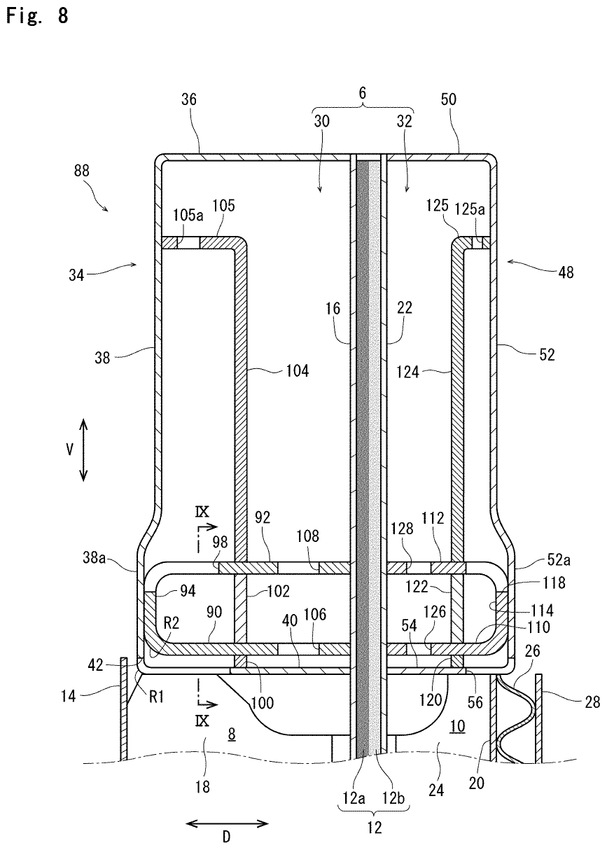

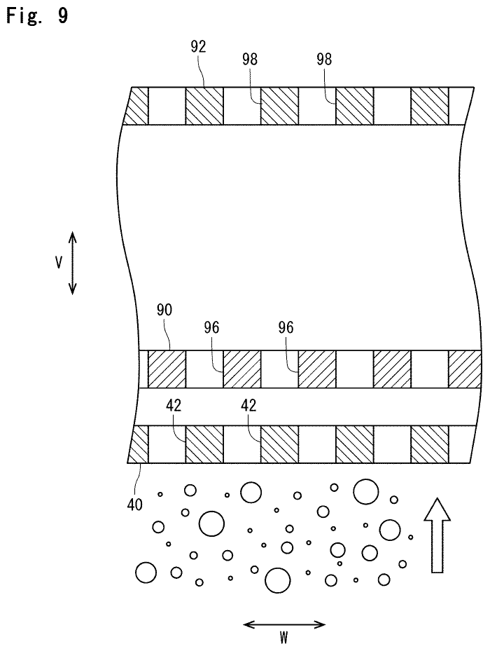

Next, a third embodiment of the electrolytic cell unit of the present invention will be described with reference to FIGS. 8 and 9. In the third embodiment as well, the same components as those in the first embodiment are given of the same reference numerals as those in the first embodiment, so that the explanation thereof is omitted.

### Anode-Side First Additional Plate 90 and Second Additional Plate 92

As shown in FIG. 8, in the electrolytic cell unit 88 of the third embodiment, a first additional plate 90 and a second additional plate 92 arranged at intervals from each other in the vertical direction are provided above the partition plate 40 that partitions off the anode chamber 8 and the gas-liquid separation chamber 30. The first and second additional plates 90 and 92 are made of a first material (for example, titanium).

### Linking Piece 94

In the illustrated embodiment, one end of the first additional plate 90 in the depth direction and one end of the second additional plate 92 in the depth direction are linked by a linking piece 94 made of the first material that extends in the vertical direction along the side wall 38 of the gas-liquid separation chamber 30. The linking piece 94 is in contact with the side wall 38, and the other ends of the first and second additional plates 90 and 92 in the depth direction are in contact with the first partition wall 16. As can be understood from FIG. 8, a portion of the side wall 38 of the third embodiment where the linking piece 94 is provided protrudes slightly outward. The protruding portion is indicated by the reference symbol 38a.

### Slits 96 and 98

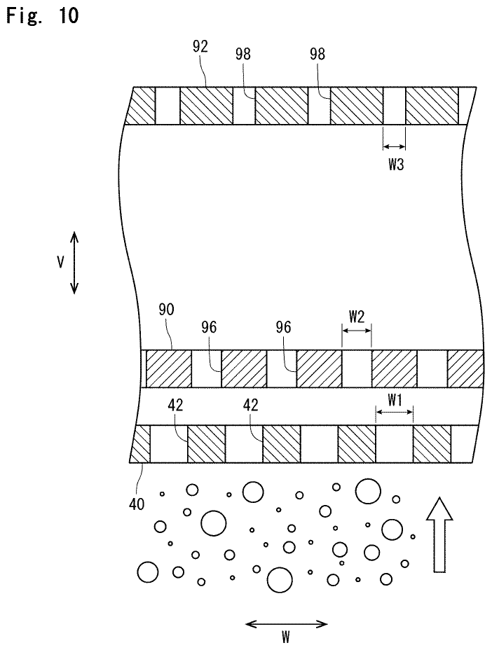

As shown in FIG. 9, a plurality of slits 96 and 98 extending in the depth direction (D direction) at intervals in the width direction (W direction) have been formed in each of the first and second additional plates 90 and 92. The slits 96 and 98 are located above the slits 42 in the partition plate 40. It is preferable that the slits 42 in the partition plate 40 and the slits 96 in the first additional plate 90 satisfy one or more of the following conditions (g) to (i).
(g) The slits 42 in the partition plate 40 and the slits 96 in the first additional plate 90 are arranged alternately in the width direction (see FIGS. 9 and 10).
(h) The width W2 of the slits 96 in the first additional plate 90 is smaller than the width W1 of the slits 42 in the partition plate 40 (W2<W1, see FIG. 10).
(i) The number of slits 96 in the first additional plate 90 is smaller than the number of slits 42 in the partition plate 40.

Furthermore, it is preferable that the slits 96 in the first additional plate 90 and the slits 98 of the second additional plate 92 also satisfy one or more of the following conditions (j) to (l).
(j) The slits 96 in the first additional plate 90 and the slits 98 in the second additional plate 92 are arranged alternately in the width direction (see FIGS. 9 and 10).
(k) The width W3 of the slits 98 in the second additional plate 92 is smaller than the width W2 of the slits 96 in the first additional plate 90 (W3<W2, see FIG. 10).
(l) The number of slits 98 in the second additional plate 92 is less than the number of slits 96 in the first additional plate 90.

### Separating Piece 100

In the illustrated embodiment, as shown in FIG. 8, a separating piece 100 made of the first material and dividing the gas-liquid separation chamber 30 in the depth direction into the side wall 38 side and the first partition wall 16 side is provided between the partition plate 40 and the first additional plate 90. The lower end of the separating piece 100 is joined or fitted to the partition plate 40, and the upper end of the separating piece 100 is joined or fitted to the first additional plate 90. The slits 42 in the partition plate 40 and the slits 96 in the first additional plate 90 are located between the separating piece 100 and the side wall 38.

However, where the following conditions (1) to (4) are satisfied, the separating piece 100 may not be provided.
(1) The slits 42 extend to at least a part of a bent portion R1 between the partition plate 40 and the protruding portion 38a of the side wall 38.
(2) The slits 96 extend to at least a portion of a bent portion R2 between the first additional plate 90 and the linking piece 94.
(3) The bending radius of the bent portion R1 is smaller than the bending radius of the bent portion R2.
(4) A gap between the flat portion of the partition plate 40 and the flat portion of the first additional plate 90 is smaller than the gap between the bent portion R1 and the bent portion R2, there is almost no flow of gas or liquid between the flat portion of the partition plate 40 and the flat portion of the first additional plate 90, and gas and liquid flow through the gap between the bent portion R1 and the bent portion R2.

### First Vertical Separating Plate 102

A vertical separating plate 102 made of the first material and dividing the gas-liquid separation chamber 30 in the depth direction into the side wall 38 side and the first partition wall 16 side is provided between the first additional plate 90 and the second additional plate 92 (directly above the separating piece 100). The lower end of the first vertical separating plate 102 is joined or fitted to the first additional plate 90, and the upper end of the first vertical separating plate 102 is joined or fitted to the second additional plate 92. The slits 98 in the second additional plate 92 are located between the first vertical separating plate 102 and the side wall 38.

### Second Vertical Separating Plate 104

A second vertical separating plate 104 made of the first material and dividing the gas-liquid separation chamber 30 in the depth direction into the side wall 38 side and the first partition wall 16 side is joined or fitted to the upper surface of the second additional plate 92 (directly above the first vertical separating plate 102). The upper end of the second vertical separating plate 104 is lower than the lower surface of the top plate 36, and liquid and gas in the gas-liquid separation chamber 30 can move over the second vertical separating plate 104. The upper end of the second vertical separating plate 104 is linked to the side wall 38 by a horizontal separating plate 105, and a plurality of openings 105a is formed in the horizontal separating plate 105 to allow the movement of liquid and gas.

The first and second additional plates 90 and 92 are provided with a plurality of through holes 106 and 108 that allows the movement of liquid and gas in the gas-liquid separation chamber 30, and the through holes 106 and 108 are arranged between the first and second vertical separating plates 102 and 104 and the first partition wall 16. The through holes 106 may not be provided in the first additional plate 90.

### Cathode-Side First Additional Plate 110 and Second Additional Plate 112

The first additional plate 110 and the second additional plate 112 are provided to be arranged at intervals from each other in the vertical direction above the partition plate 54 that partitions off the cathode chamber 10 and the gas-liquid separation chamber 32. The first and second additional plates 110 and 112 are made of a second material (for example, nickel).

### Linking Piece 114

In the illustrated embodiment, one end of the first additional plate 110 in the depth direction and one end of the second additional plate 112 in the depth direction are linked by a linking piece 114 made of the second material that extends in the vertical direction along the side wall 52 of the gas-liquid separation chamber 32. The linking piece 114 is in contact with the side wall 52, and the other ends of the first and second additional plates 110 and 112 in the depth direction are in contact with the second partition wall 22. A portion of the side wall 52 where the linking piece 114 is provided protrudes slightly outward. The protruding portion is indicated by the reference symbol 52a.

### Slits

Although not illustrated, a plurality of slits extending in the depth direction (D direction) at intervals in the width direction (W direction) have been formed in the first additional plate 110. Further, a plurality of slits 118 (see FIG. 8) extending in the depth direction (D direction) at intervals in the width direction (W direction) have also been formed in the second additional plate 112.

The slits in the first additional plate 110 and the slits 118 in the second additional plate 112 are located above the slits 56 in the partition plate 54. It is preferable that the slits 56 in the partition plate 54 and the slits in the first additional plate 110 satisfy one or more of the following conditions (m) to (o).
(m) The slits 56 in the partition plate 54 and the slits in the first additional plate 110 are arranged alternately in the width direction.
(n) The width of the slits in the first additional plate 110 is smaller than the width of the slits 56 in the partition plate 54.
(o) The number of slits in the first additional plate 110 is smaller than the number of slits 56 in the partition plate 54.

Furthermore, it is preferable that the slits in the first additional plate 110 and the slits 118 in the second additional plate 112 satisfy one or more of the following conditions (p) to (r).
(p) The slits in the first additional plate 110 and the slits 118 in the second additional plate 112 are arranged alternately in the width direction.
(q) The width of the slits 118 in the second additional plate 112 is smaller than the width of the slits in the first additional plate 110.
   (r) The number of slits 118 in the second additional plate 112 is smaller than the number of slits in the first additional plate 110.

### Separating Piece 120

A separating piece 120 made of the second material and dividing the gas-liquid separation chamber 32 in the depth direction into the side wall 52 side and the second partition wall 22 side is provided between the partition plate 54 and the first additional plate 110. The lower end of the separating piece 120 is joined or fitted to the partition plate 54, and the upper end of the separating piece 120 is joined or fitted to the first additional plate 110. The slits 56 in the partition plate 54 and the slits in the first additional plate 110 are located between the separating piece 120 and the side wall 52. In the case where the conditions corresponding to (1) to (4) above are satisfied, the separating piece 120 may not be provided.

### First Vertical Separating Plate 122

A vertical separating plate 122 made of the second material and dividing the gas-liquid separation chamber 32 in the depth direction into the side wall 52 side and the second partition wall 22 side is provided between the first additional plate 110 and the second additional plate 112 (directly above the separating piece 120). The lower end of the first vertical separating plate 122 is joined or fitted to the first additional plate 110, and the upper end of the first vertical separating plate 122 is joined or fitted to the second additional plate 112. The slits 118 of the second additional plate 112 are located between the first vertical separating plate 122 and the side wall 52.

### Second Vertical Separating Plate 124

A second vertical separating plate 124 made of a second material and dividing the gas-liquid separation chamber 32 in the depth direction into the side wall 52 side and the second partition wall 22 side is joined or fitted to the upper surface of the second additional plate 112 (directly above the first vertical separating plate 122). The upper end of the second vertical separating plate 124 is lower than the lower surface of the top plate 50, and liquid and gas in the gas-liquid separation chamber 32 can move over the second vertical separating plate 124. The upper end of the second vertical separating plate 124 is linked to the side wall 52 by a horizontal separating plate 125, and a plurality of openings 125a to allow the movement of liquid and gas have been formed in the horizontal separating plate 125.

The first and second additional plates 110 and 112 are provided with a plurality of through holes 126 and 128 that allows the movement of liquid and gas in the gas-liquid separation chamber 32, and the through holes 126 and 128 are arranged between the first and second vertical separating plates 122 and 124 and the second partition wall 22. The through holes 126 may not be provided in the first additional plate 110.

In the third embodiment as well, the gas bubble-containing electrolytic solution rises from the anode chamber 8 to the anode-side gas-liquid separation chamber 30, and the gas bubble-containing electrolyte also rises from the cathode chamber 10 to the cathode-side gas-liquid separation chamber 32. When the bubble-containing electrolyte passes through the slits 42 and 56 in the partition plates 40 and 54, the bubbles coalesce and split.

Furthermore, the bubbles also coalesce and split when passing through the slits 96 in the first additional plate 90 and the slits in the first additional plate 110, and the bubbles also coalesce and split when passing through the slits 98 and 118 in the second additional plates 92 and 112. Therefore, in the third embodiment, the coalescence and splitting of bubbles is promoted more than in the first and second embodiments, thereby improving gas-liquid separation.

Furthermore, as shown in FIG. 9, where the slits 42 in the anode-side partition plate 40 and the slits 96 in the first additional plate 90 are arranged alternately in the width direction, and the slits 96 in the first additional plate 90 and the slits 98 in the second additional plate 92 are arranged alternately in the width direction, and where on the cathode side as well, the slits 56 in the partition plate 54 and the slits in the first additional plate 110 are arranged alternately in the width direction, and the slits in the first additional plate 110 and the slits 118 in the second additional plate 112 are arranged alternately in the width direction (where the above conditions (g), (j), (m), and (p) are satisfied), the coalescence and splitting of the bubbles is further promoted. In addition, in the case where the conditions (h), (k), (n), and (q) related to the width of the slits, or the conditions (i), (l), (o), and (r) related to the number of slits, are satisfied, the coalescence and splitting of the bubbles are promoted more effectively.

When multiple electrolytic cell units 88 are arranged side by side in the depth direction and pressed from both sides in the depth direction, the first flange member 34 and the second flange member 48 are pressed against each other with a gasket (not shown) interposed therebetween. Specifically, the protruding portion 38a of the side wall 38 and the protruding portion 52a of the side wall 52 are pressed against each other with the gasket interposed therebetween.

As described above, in the third embodiment, the anode-side first and second additional plates 90 and 92 are linked by a linking piece 94 extending vertically along the side wall 38 of the gas-liquid separation chamber 30, and the cathode-side first and second additional plates 110 and 112 are also linked by a linking piece 114 extending vertically along the side wall 52 of the gas-liquid separation chamber 32.

As a result, the first flange member 34 is reinforced by the first and second additional plates 90 and 92 and the linking piece 94, and the second flange member 48 is also reinforced by the first and second additional plates 110 and 112 and the linking piece 114. As a result, the thickness of the first and second flange members 34 and 48 can be reduced to reduce costs. Furthermore, even if the thickness of the first and second flange members 34 and 48 is reduced, a decrease in the surface pressure between the first flange member 34 and the second flange member 48 can be prevented.

### Description of Reference Numerals

2 Electrolytic cell unit (first embodiment)
4 Electrode chamber
6 Gas-liquid separation chamber
8 Anode chamber
10 Cathode chamber
30 Anode-side gas-liquid separation chamber
32 Cathode-side gas-liquid separation chamber
38 Side wall (anode side)
40 Partition plate (anode side)
42 Slit (anode side)
52 Side wall (cathode side)
54 Partition plate (cathode side)
56 Slit (cathode side)
68 Electrolytic cell unit (second embodiment)
70 Additional plate (anode side)
72 Slit
80 Additional plate (cathode side)
88 Electrolytic cell unit (third embodiment)
90 First additional plate (anode side)
92 Second additional plate (anode side)
94 Linking piece
96 Slit (first additional plate)
98 Slit (second additional plate)
110 First additional plate (cathode side)
112 Second additional plate (cathode side)
114 Linking piece
118 Slit (second additional plate)

1. An electrolytic cell unit comprising an electrode chamber and a gas-liquid separation chamber arranged above the electrode chamber, wherein
a partition plate partitioning off the electrode chamber and the gas-liquid separation chamber has a plurality of slits extending in a depth direction at intervals in a width direction.

2. The electrolytic cell unit of claim 1, wherein an additional plate is provided above the partition plate, and the additional plate has a plurality of slits extending in the depth direction at intervals in the width direction.

3. The electrolytic cell unit of claim 2, wherein the slits in the partition plate and the slits in the additional plate are arranged alternately in the width direction.

4. The electrolytic cell unit of claim 2, wherein the width of the slits in the additional plate is smaller than the width of the slits in the partition plate.

5. The electrolytic cell unit of claim 2, wherein the number of slits in the additional plate is less than the number of slits in the partition plate.

6. The electrolytic cell unit of claim 1, wherein a first additional plate and a second additional plate arranged at intervals from each other in a vertical direction are provided above the partition plate, and
each of the first additional plate and the second additional plate has a plurality of slits extending in the depth direction at intervals in the width direction.

7. The electrolytic cell unit of claim 6, wherein the slits in the partition plate and the slits in the first additional plate are arranged alternately in the width direction.

8. The electrolytic cell unit of claim 6, wherein the width of the slits in the first additional plate is smaller than the width of the slits in the partition plate.

9. The electrolytic cell unit of claim 6, wherein the number of slits in the first additional plate is less than the number of slits in the partition plate.

10. The electrolytic cell unit of claim 6, wherein the slits in the first additional plate and the slits in the second additional plate are arranged alternately in the width direction.

11. The electrolytic cell unit of claim 6, wherein the width of the slits in the second additional plate is smaller than the width of the slits in the first additional plate.

12. The electrolytic cell unit of claim 6, wherein the number of slits in the second additional plate is smaller than the number of slits in the first additional plate.

13. The electrolytic cell unit of claim 6, wherein the first additional plate and the second additional plate are linked by a linking piece extending in the vertical direction along a side wall of the gas-liquid separation chamber.
